(19) United States
(12) Patent Application Publication
(10) Pub. No.: US 2022/0105756 A1
(43) Pub. Date: Apr. 7, 2022

(54) PNEUMATIC TIRE

(71) Applicant: The Yokohama Rubber Co., LTD., Tokyo (JP)

(72) Inventor: Yuki NAGAHASHI, Kanagawa (JP)

(21) Appl. No.: 17/275,544

(22) PCT Filed: Aug. 21, 2019
(86) PCT No.: PCT/JP2019/032574

§ 371 Date: Mar. 11, 2021

(30) Foreign Application Priority Data
Sep. 18, 2018 (JP) 2018-173579

(51) Int. Cl. B60C 11/12

(52) U.S. Cl. CPC B60C 11/1218; B60C 2011/0353; B60C 2011/1213

(57) ABSTRACT

A pneumatic tire includes a tread with inner and outer main grooves; a center land portion between the inner main grooves; intermediate land portions between the inner main grooves and the outer main grooves; and shoulder land portions outward of the outer main grooves. The land portions include sipes having a three-dimensional shape; the intermediate land portions include lug grooves having a bent portion; the lug grooves include one end that opens to one of the outer main grooves and the other end that terminates within the intermediate land portion; a groove width of the inner main grooves is from 28% to 33% with respect to a width of the center land portion and of the intermediate land portions; and a groove width of the outer main grooves is from 28% to 33% with respect to the width of the center land portion and of the intermediate land portions.

### TECHNICAL FIELD

The present technology relates to a pneumatic tire suitable as an all-season tire and particularly relates to a pneumatic tire that can provide enhanced snow performance while maintaining good steering stability on dry road surfaces.

### BACKGROUND ART

There is a demand for an all-season tire that can exhibit excellent snow performance during snowfall. Accordingly, in the related art, there is known an all-season tire that includes a tread portion provided with a plurality of main grooves extending in a tire circumferential direction and land portions defined by the plurality of main grooves, the land portions including a plurality of sipes or lug grooves extending in a tire width direction, so as to ensure snow traction based on the plurality of sipes or lug grooves (for example, see Japan Unexamined Patent Publication Nos. 2009-173241 and 2009-214761).

Furthermore, ensuring good snow performance by forming a plurality of lug grooves including a bent portion in the land portions of the tread portion and by diversifying the extension directions of edge components by the plurality of lug grooves including the bent portion has been proposed (for example, see Japan Patent No. 5181927).

However, in a configuration in which the plurality of lug grooves including the bent portion are disposed in the land portions of the tread portion, the rigidity of the land portions decreases, and steering stability on dry road surfaces decreases therewith. Thus, it is difficult to provide steering stability on dry road surfaces and snow performance in a compatible manner.

### SUMMARY

The present technology provides a pneumatic tire that can provide enhanced snow performance while maintaining good steering stability on dry road surfaces.

A pneumatic tire according to an embodiment of the present technology includes: a tread portion extending in a tire circumferential direction and having an annular shaper; a pair of sidewall portions disposed on both sides of the tread portion; and a pair of bead portions disposed on an inner side in a tire radial direction of the pair of sidewall portions. The tread portion includes a pair of inner main grooves extending in the tire circumferential direction on both sides of a tire equator and a pair of outer main grooves extending in the tire circumferential direction on an outer side of the pair of inner main grooves, a center land portion is defined between each of the pair of inner main grooves, intermediate land portions are defined between the pair of inner main grooves and the pair of outer main grooves, shoulder land portions are defined on an outer side of the pair of outer main grooves, each of the center land portion, the intermediate land portions, and the shoulder land portions includes a plurality of sipes having a three-dimensional shape, the plurality of sipes being disposed at intervals in the tire circumferential direction, each of the intermediate land portions includes a plurality of lug grooves including a bent portion, the plurality of lug grooves being disposed at intervals in the tire circumferential direction, each of the plurality of lug grooves including the bent portion includes one end portion that opens to one of the pair of outer main grooves and an other end portion that terminates within the intermediate land portion, a groove width W1 of the pair of inner main grooves falls within a range of from 28% to 33% with respect to the width of the center land portion and the width of the intermediate land portions, and a groove width W2 of the pair of outer main grooves falls within a range of from 28% to 33% with respect to the width of the center land portion and the width of the intermediate land portions.

In an embodiment of the present technology, a pneumatic tire provides enhanced snow performance based on: the plurality of sipes in each of the center land portion, the intermediate land portions, and the shoulder land portions; and the plurality of lug grooves including a bent portion in the intermediate land portions. By configuring the plurality of sipes to have a three-dimensional shape, the decrease in the rigidity of each of the land portions can be minimized and good steering stability on dry road surfaces can be maintained. Moreover, the groove width W1 of the pair of inner main grooves and the groove width W2 of the pair of outer main grooves can be specified with respect to the width of the center land portion and the width of the intermediate land portions to provide steering stability on dry road surfaces and snow performance in a compatible manner. This configuration can enhance snow performance while maintaining good steering stability on dry road surfaces.

In an embodiment of the present technology, the groove width W1 of the pair of inner main grooves and the groove width W2 of the pair of outer main grooves preferably satisfy the relationship W1<W2. In particular, the groove width W1 of the pair of inner main grooves and the groove width W2 of the pair of outer main grooves preferably satisfy the relationship 0.85≤W1/W2≤0.95. The groove width W2 of the pair of outer main grooves, to which the plurality of lug grooves including a bent portion open, can be configured to be relatively large so as to enhance wet performance and snow performance and to maintain good steering stability on dry road surfaces.

Each of the plurality of lug grooves of the intermediate land portion preferably includes a bent portion with an acute angle, and the plurality of sipes having a three-dimensional shape and the plurality of lug grooves including a bent portion preferably communicate with each other in the intermediate land portion. Thus, by configuring each of the plurality of lug grooves in the intermediate land portion to include a bent portion with an acute angle, the edge components can be increased while sufficiently ensuring the rigidity of the intermediate land portion, and steering stability on dry road surfaces and snow performance can be effectively enhanced. Furthermore, the configuration in which the plurality of sipes having a three-dimensional shape and the plurality of lug grooves including a bent portion communicate with each other in the intermediate land portion contributes to enhancing snow performance.

The center land portion preferably has a configuration in which: the center land portion includes a plurality of lug grooves extending in the tire width direction; the plurality of sipes having a three-dimensional shape and the plurality of lug grooves are connected to each other in the center land portion; and each of the plurality of sipes having a three-dimensional shape and each of the plurality of lug grooves open to either one of the pair of inner main grooves. This configuration can ensure edge components in the center land portion and effectively enhance snow performance.

Preferably, each of the plurality of lug grooves including a bent portion includes a first groove portion extending from an opening end to a bend point and a second groove portion extending from the bend point to a closed end, and an intersection angle formed by the first groove portion formed in the intermediate land portions and one of the plurality of sipes having a three-dimensional shape formed in the intermediate land portions falls within a range of from 45° to 90°, and a length a of the first groove portion and a length b of the second groove portion satisfy the relationship 0.05×a≤b≤0.4×a. This configuration can effectively enhance steering stability on dry road surfaces and snow performance.

The shoulder land portion preferably includes a plurality of lug grooves extending in the tire width direction, the plurality of lug grooves not communicating with the pair of outer main grooves, and a plurality of longitudinal grooves connecting, in the tire circumferential direction, the plurality of lug grooves adjacent to each other. In a configuration in which the plurality of lug grooves and the plurality of longitudinal grooves are formed in the shoulder land portion, snow performance can be enhanced based on the plurality of lug grooves and the plurality of longitudinal grooves. Moreover, by configuring the plurality of lug grooves disposed in the shoulder land portion so as not to communicate with the outer main grooves, the rigidity of the shoulder land portion can be ensured, and steering stability on dry road surfaces can be enhanced.

In an embodiment of the present technology, a sipe having a three-dimensional shape means a sipe that includes a pair of opposing sipe wall surfaces that bend into a three-dimensional shape, each of the pair of sipe wall surfaces including a plurality of types of inclined surfaces that are mutually different in inclination direction with respect to a sipe depth direction observed on a plane orthogonal to a sipe length direction and a plurality of types of inclined surfaces that are mutually different in inclination direction with respect to the sipe length direction observed on a plane orthogonal to the sipe depth direction. The land portions including the plurality of sipes having a three-dimensional shape have the characteristics of not easily flexing in a sipe thickness direction (i.e., the tire circumferential direction) and the sipe length direction (i.e., the tire width direction) due to the mating between the pair of opposing sipe wall surfaces.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of a pneumatic tire according to an embodiment of the present technology.

FIG. 3 is a plan view extracting and illustrating a center land portion, an intermediate land portion, and a shoulder land portion in the tread pattern of FIG. 2. Note that the shoulder land portion is a portion within a ground contact region.

FIG. 4 is a notch perspective view illustrating an example of a sipe having a three-dimensional shape.

### DETAILED DESCRIPTION

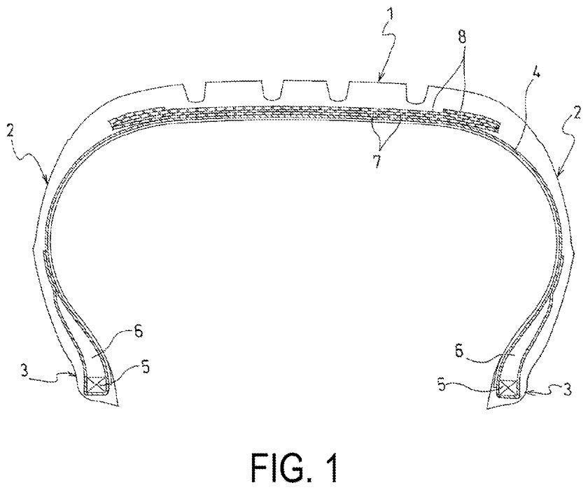

Configurations of embodiments of the present technology will be described in detail below with reference to the accompanying drawings. FIGS. 1 to 3 illustrate a pneumatic tire according to an embodiment of the present technology. As illustrated in FIG. 1, a pneumatic tire of the present embodiment includes an annular tread portion 1 extending in the tire circumferential direction, a pair of sidewall portions 2, 2 disposed on both sides of the tread portion 1, and a pair of bead portions 3, 3 disposed on an inner side of the sidewall portions 2 in the tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5.

A plurality of belt layers 7 are embedded on the outer circumferential side of the carcass layer 4 in the tread portion 1. Each of the belt layers 7 includes a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall within a range of from 10° to 40°, for example. Steel cords are preferably used as the reinforcing cords of the belt layers 7. To improve high-speed durability, at least one belt cover layer 8, formed by disposing reinforcing cords at an angle of, for example, not greater than 5° with respect to the tire circumferential direction, is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, and the pneumatic tire is not limited thereto.

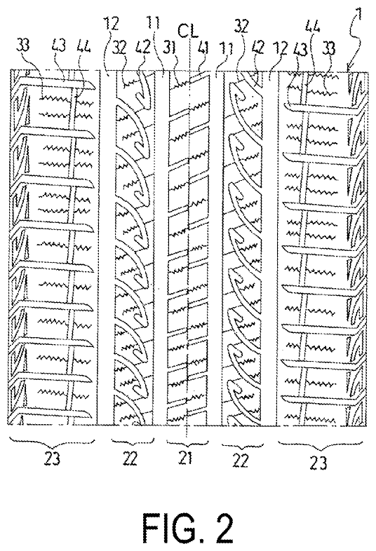

In FIG. 2, CL denotes a tire equator. As illustrated in FIG. 2, the tread portion 1 includes a pair of inner main grooves 11 extending in the tire circumferential direction at positions on both sides of a tire equator CL and a pair of outer main grooves 12 extending in the tire circumferential direction at positions on an outer side of the pair of inner main grooves 11 in the tire width direction.

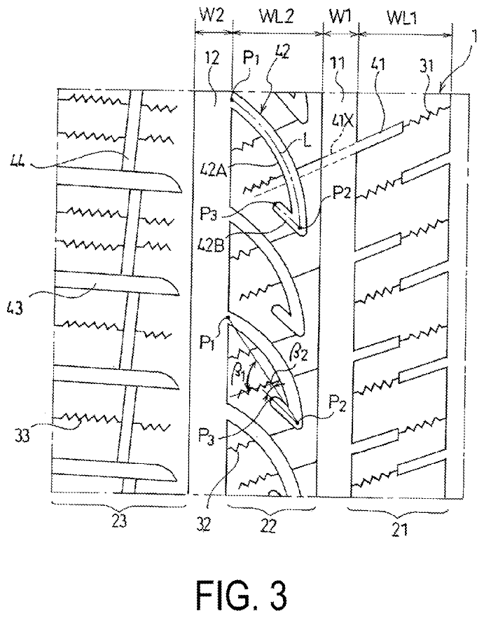

Accordingly, a center land portion 21 extending in the tire circumferential direction is defined between the pair of inner main grooves 11, 11; intermediate land portions 22 extending in the tire circumferential direction are defined between the pair of inner main grooves 11 and the pair of outer main grooves 12; and shoulder land portions 23 are defined on an outer side of the pair of outer main grooves 12 in the tire width direction. As illustrated in FIG. 3, the groove width W1 of one of the pair of inner main grooves 11 is set to fall within a range of from 28% to 33% with respect to a width WL1 of the center land portion 21 and a width WL2 of one of the intermediate land portions 22, and the groove width W2 of one of the pair of outer main grooves 12 is set to fall within a range of from 28% to 33% with respect to the width WL1 of the center land portion 21 and the width WL2 of the intermediate land portions 22. Furthermore, the groove width W1 of the inner main groove 11 and the groove width W2 of the outer main groove 12 are preferably set to fall within a range of from 5.0 mm to 15.0 mm, the groove depths thereof being set to fall within a range of from 6.0 mm to 10.0 mm.

The center land portion 21 located on the tire equator CL includes a plurality of sipes 31 extending in the tire width direction, the plurality of sipes 31 having a three-dimensional shape, and a plurality of lug grooves 41 extending in the tire width direction. The plurality of sipes 31 have a groove width of 1.5 mm or less, and the plurality of lug grooves 41 have a groove width of more than 1.5 mm, and more preferably from more than 1.5 mm to 3.0 mm. The plurality of sipes 31 and the plurality of lug grooves 41 are disposed at an identical angle with respect to the tire circumferential direction and are connected to each other, and each of the plurality of sipes 31 and each of the plurality of lug grooves 41 open to either one of the pair of inner main grooves 11, 11. In a more preferable embodiment, of the plurality of sipes 31, those communicating with one of the pair of inner main grooves 11 and those communicating with the other of the pair of inner main grooves 11 are alternately disposed along the tire circumferential direction, and of the plurality of lug grooves 41, those communicating with the other of the pair of inner main grooves 11 and those communicate with one of the pair of inner main grooves 11 are alternately disposed along the tire circumferential direction.

Each of the intermediate land portions 22 located on an outer side of the pair of inner main grooves 11 includes a plurality of sipes 32 extending in the tire width direction, the plurality of sipes 32 having a three-dimensional shape, and a plurality of lug grooves 42 including a bent portion, each of the plurality of lug grooves 42 including one end portion that opens to one of the pair of outer main grooves 12 and an other end portion that terminates within the intermediate land portion 22. The plurality of sipes 32 of the intermediate land portion 22 have a groove width of 1.5 mm or less and are oriented in an identical direction to the plurality of sipes 31 of the center land portion 21. Each of the plurality of lug grooves 42 is bent in the shape of a fishing hook and is bent at a bend point P₂ on a center line L. The lug groove 42 has a first groove portion 42A extending from an opening end P₁ to the bend point P₂ and a second groove portion 42B extending from the bend point P₂ to a closed end P₃.

Each of the shoulder land portions 23 located on an outer side of the pair of outer main grooves 12 includes a plurality of lug grooves 43 extending in the tire width direction and a plurality of longitudinal grooves 44 connecting in the tire circumferential direction the plurality of lug grooves 43 adjacent to each other. Each of the plurality of lug grooves 43 does not communicate with the outer main groove 12. Furthermore, the shoulder land portion 23 includes a plurality of sipes 33 extending in the tire width direction, the plurality of sipes 33 having a three-dimensional shape. The plurality of sipes 33 have a groove width of 1.5 mm or less, and do not communicate with the outer main grooves 12.

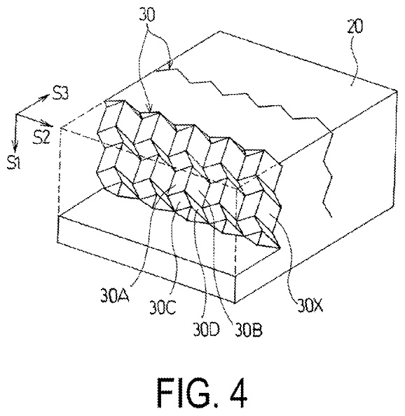

FIG. 4 illustrates an example of a sipe having a three-dimensional shape. In FIG. 4, S1 is a sipe depth direction, S2 is a sipe length direction, and S3 is a sipe thickness direction. The sipe 30 having a three-dimensional shape has a pair of opposing sipe wall surfaces 30X, 30X, and the pair of sipe wall surfaces 30X, 30X are bent into a three-dimensional shape. Each of the pair of sipe wall surfaces 30X includes four types of inclined surfaces 30A, 30B, 30C, 30D, and the inclined surfaces 30A, 30B, 30C, 30D are disposed regularly and repeatedly. The inclined surface 30A and the inclined surface 30C are mutually different in inclination direction with respect to the sipe depth direction S1 observed on a plane orthogonal to the sipe length direction; the inclined surface 30B and the inclined surface 30D are mutually different in inclination direction with respect to the sipe depth direction S1 observed on a plane orthogonal to the sipe length direction; the inclined surface 30A and the inclined surface 30B are mutually different in inclination direction with respect to the sipe length direction S2 observed on a plane orthogonal to the sipe depth direction; and the inclined surface 30C and the inclined surface 30D are mutually different in inclination direction with respect to the sipe length direction S2 observed on a plane orthogonal to the sipe depth direction. Accordingly, the sipe 30 forms a zigzag shape on a road contact surface of a land portion 20 (corresponding to a plane orthogonal to the sipe depth direction) and on a side surface thereof (corresponding to a plane orthogonal to the sipe length direction). The land portion 20 that includes the sipe 30 having a three-dimensional shape has the characteristics of not easily flexing in the sipe thickness direction S3 (i.e., the tire circumferential direction) and in the sipe length direction S2 (i.e., the tire width direction), due to the mating of the pair of sipe wall surfaces 30X, 30X. Any one of the sipes 31 to 33 described above has a three-dimensional shape similar to that of the sipe 30 in at least one portion in the longitudinal direction.

In the pneumatic tire described above, the plurality of sipes 31 in the center land portion 21 and the plurality of lug grooves 41, the plurality of sipes 31 in the intermediate land portion 22 and the plurality of lug grooves 42 including a bent portion, and the plurality of sipes 33 in the shoulder land portion 23 and the plurality of lug grooves 43 contribute to enhancing snow performance. However, in a configuration in which the center land portion 21, the intermediate land portion 22, and the shoulder land portion 23 are subdivided by the sipes 31 to 33 and the lug grooves 41 to 43, the decrease in rigidity becomes significant. In particular, the plurality of lug grooves 42 including a bent portion, though preferable from the perspective of edge effect, significantly reduce the rigidity of the intermediate land portion 22. Thus, the sipes 31 to 33 can be configured to have a three-dimensional shape so as to minimize the decrease in the rigidity of each of the land portions 21 to 23 and maintain good steering stability on dry road surfaces.

Further, as described above, the groove width W1 of the inner main groove 11 and the groove width W2 of the outer main groove 12 can be defined with respect to the width WL1 of the center land portion 21 and the width WL2 of the intermediate land portion 22 to provide steering stability on dry road surfaces and snow performance in a compatible manner. Here, when the groove width W1 of the inner main groove 11 or the groove width W2 of the outer main groove 12 is less than 28% of the width WL1 of the center land portion 21 and the width WL2 of the intermediate land portion 22, snow performance cannot be ensured sufficiently, and on the other hand, when greater than 33%, steering stability on dry road surfaces cannot be ensured sufficiently.

In the pneumatic tire described above, the groove width W1 of the inner main groove 11 and the groove width W2 of the outer main groove 12 preferably satisfy the relationship W1<W2. In particular, the groove width W1 of the inner main groove 11 and the groove width W2 of the outer main groove 12 preferably satisfy the relationship 0.85≤W1/W2≤0.95. The groove width W2 of the outer main groove 12, to which the plurality of lug grooves 42 including a bent portion open, can be configured to be relatively large so as to further enhance wet performance and snow performance and to maintain good steering stability on dry road surfaces. Here, when W1/W2<0.85, the inner main groove 11 becomes excessively narrow, and thus the effect of enhancing wet performance and snow performance will decrease, and on the other hand, when W1/W2>0.95, the effect of providing steering stability on dry road surfaces and wet performance and snow performance in a compatible manner will decrease.

The pneumatic tire described above preferably has a configuration in which: the center land portion 21 includes the plurality of sipes 31 having a three-dimensional shape and the plurality of lug grooves 41 extending in the tire width direction; the plurality of sipes 31 having a three-dimensional shape and the plurality of lug grooves 41 are connected to each other; and each of the plurality of sipes 31 having a three-dimensional shape and each of the plurality of lug grooves 41 open to either one of the pair of inner main grooves 11. This configuration can sufficiently ensure the edge components in the center land portion 21 and effectively enhance snow performance. In particular, the rigidity of the center land portion 21 can be ensured in comparison with a configuration in which the center land portion 21 is divided only by thick grooves extending in the tire width direction, and snow discharge properties can be enhanced in comparison with a configuration in which the center land portion 21 is divided only by thin sipes extending in the tire width direction.

As illustrated in FIG. 3, the pneumatic tire described above, when assumed to have an imaginary extension portion 41X formed by extending the lug groove 41 toward the inner main groove 11 to which the lateral groove 41 opens, preferably has a configuration in which a second groove portion 42B of the lug groove 42 is disposed so as not to overlap with the imaginary extension portion 41X of the lateral groove 41. The position of the second groove portion 42B of the lug groove 42 and the position of the imaginary extension portion 41X of the lateral groove 41 can be configured so as not to overlap with each other, thus preventing the rigidity of the tread portion 1 from decreasing locally on the tire circumference and improving snow performance while maintaining good steering stability on dry road surfaces.

The pneumatic tire described above preferably has a configuration in which: each of the plurality of lug grooves 42 in the intermediate land portion 22 includes a bent portion with an acute angle, and the plurality of sipes 32 having a three-dimensional shape and the plurality of lug grooves 42 including the bent portion communicate with each other in the intermediate land portion 22. Thus, by configuring each of the plurality of lug grooves in the intermediate land portion 22 to include a bent portion with an acute angle, the edge components can be increased while sufficiently ensuring the rigidity of the intermediate land portion 22, and steering stability on dry road surfaces and snow performance can be effectively enhanced. Furthermore, the configuration in which the plurality of sipes 32 having a three-dimensional shape and the plurality of lug grooves 42 including a bent portion communicate with each other in the intermediate land portion 22 contributes to enhancing snow performance.

An intersection angle β₁ of the first groove portion 42A forming the lug groove 42 with respect to one of the plurality of sipes 32 is preferably set to fall within a range of from 45° to 90°. The intersection angle β₁ is an angle formed by a straight line connecting the opening end P₁ of the lug groove 42 and the bend point P₂ thereof with respect to a center line of the sipe 32. By setting the intersection angle β₁ to fall within the range described above, the rigidity of the intermediate land portion 22 can be sufficiently ensured. When the intersection angle β₁ is less than 45°, the effect of enhancing steering stability on dry road surfaces decreases.

Furthermore, a bend angle β₂ of the second groove portion 42B forming the lug groove 42 with respect to the first groove portion 42A is preferably set to fall within a range of from 0° to 90°, and more preferably within a range of from 0° to 45°. The bend angle β₂ is an angle formed by a straight line connecting the bend point P₂ of the lug groove 42 and the closed end P₃ thereof with respect to the straight line connecting the opening end P₁ and the bend point P₂. The bent portion with an acute angle of the lug groove 42 is defined as described above based on the bend angle β₂. Setting the bend angle β₂ to fall within the range described above can increase the edge components while sufficiently ensuring the rigidity of the intermediate land portion 22. Here, when the bend angle β₂ is greater than 90°, it becomes difficult to increase the edge components while sufficiently ensuring the rigidity of the intermediate land portion 22.

Further, a length a of the first groove portion 42A and a length b of the second groove portion 42B, both of which form the lug groove 42, preferably satisfy the relationship 0.05×a≤b<0.4×a. The length a of the first groove portion 42A is a length from the opening end P₁ to the bend point P₂ measured along the center line L of the lug groove 42, and the length b of the second groove portion 42B is a length from the bend point P₂ to the closed end P₃ measured along the center line L of the lug groove 42. By setting the relationship between the length a of the first groove portion 42A and the length b of the second groove portion 42B as described above, steering stability on dry road surfaces and snow performance can be effectively enhanced. Here, when the length b of the second groove portion 42B of the lug groove 42 is shorter than 0.05 times the length a of the first groove portion 42A, the effect of enhancing snow performance decreases, and on the other hand, when greater than 0.4 times the length a of the first groove portion 42A, the effect of enhancing steering stability on dry road surface decreases. In particular, the length a of the first groove portion 42A and the length b of the second groove portion 42B preferably satisfy the relationship 0.1×a≤b<0.3×a.

The pneumatic tire described above preferably has a configuration in which the shoulder land portion 23 includes the plurality of lug grooves 43 extending in the tire width direction, the plurality of lug grooves 43 not communicating with the outer main grooves 12, and the plurality of longitudinal grooves 44 connecting in the tire circumferential direction the plurality of lug grooves 43, 43 adjacent to each other. This configuration can enhance snow performance based on the plurality of lug grooves 43 and the plurality of longitudinal grooves 44. Moreover, the plurality of lug grooves 43 disposed in the shoulder land portion 23 do not communicate with the outer main grooves 12, and thus the rigidity of the shoulder land portion 23 can be ensured, and steering stability on dry road surfaces can be enhanced.

### EXAMPLES

Tires of the Conventional Example, Comparative Examples 1 to 3, and Examples 1 to 5 were manufactured. The tires are pneumatic tires having a tire size of 235/55R19 and including: an annular tread portion extending in a tire circumferential direction; a pair of sidewall portions disposed on both sides of the tread portion; and a pair of bead portions disposed on an inner side in a tire radial direction of the pair of sidewall portions. The tread portion includes a pair of inner main grooves extending on both sides of a tire equator in the tire circumferential direction and a pair of outer main grooves extending on an outer side of the pair of inner main grooves in the tire circumferential direction; a center land portion is defined between each of the pair of inner main grooves; intermediate land portions are defined between the pair of inner main grooves and the pair of outer main grooves; shoulder land portions are defined on an outer side of the pair of outer main grooves; and the center land portion includes a plurality of sipes; each of the intermediate land portions includes a plurality of sipes and a plurality of lug grooves; and each of the shoulder land portions includes a plurality of sipes and a plurality of lug grooves. Each of the lug grooves in the intermediate land portion includes one end portion opening to one of the pair of outer main grooves and the other end portion terminating within the intermediate land portion. Furthermore, the center land portion and the intermediate land portion are the same width (WL1=WL2).

In the Conventional Example, Comparative Examples 1 to 3, and Examples 1 to 5, the shape of the plurality of sipes, the ratio of the groove width W1 of the pair of inner main grooves to the width WL1 of the center land portion (W1/WL1×100%), the ratio of the groove width W2 of the pair of outer main grooves to the width WL1 of the center land portion (W2/WL1×100%), the ratio of the groove width W1 of the pair of inner main grooves to the groove width W2 of the pair of outer main grooves (W1/W2×100%), the presence of the plurality of lug grooves in the center land portion, the presence of a bent portion in the plurality of lug grooves in the intermediate land portion, and a bend angle of the plurality of lug grooves in the intermediate land portion were set as shown in Table 1. A configuration in which a pair of opposing sipe wall surfaces have a three-dimensional shape as in FIG. 4 is denoted as “3D”, and a configuration in which a pair of opposing sipe wall surfaces have a constant zigzag shape across an entire region in a sipe depth direction is denoted as “2D”. Furthermore, in a configuration in which the center land portion includes a plurality of lug grooves, the plurality of sipes and the plurality of lug grooves are configured to be connected to each other in the center land portion, and each of the plurality of sipes and each of the plurality of lug grooves are configured to open to either one of the pair of inner main grooves.

The test tires were evaluated for steering stability on snow and steering stability on dry road surfaces according to the following evaluation method, and the results are also shown in Table 1.

### Steering Stability on Snow:

Each of the test tires was assembled on a wheel having a rim size of 19×7.5 J, inflated to an air pressure of 230 kPa, and mounted on a test vehicle (four wheel drive vehicle) having an engine displacement of 2400 cc, and a traveling test was conducted on a test course built on snow, the test course being assumed to be an urban area, and a sensory evaluation on steering stability on snow was carried out by a test driver. Evaluation results are expressed as index values with the value of the Conventional Example being defined as 100. Larger index values indicate superior steering stability on snow.

### Steering Stability on Dry Road Surfaces:

Each of the test tires was assembled on a wheel having a rim size of 19×7.5 J, inflated to an air pressure of 230 kPa, and mounted on a test vehicle (four wheel drive vehicle) having an engine displacement of 2400 cc, and a traveling test was conducted on a test course consisting of dry road surfaces, and a sensory evaluation on steering stability on dry road surfaces was carried out by a test driver. Evaluation results are expressed as index values with the value of the Conventional Example being defined as 100. Larger index values indicate superior steering stability on dry road surfaces.

TABLE 1

| | Conventional | Comparative | Comparative | Comparative |
|---|---|---|---|---|
| | example | Example 1 | Example 2 | Example 3 |
| Shape of the sipe | 2D | 2D | 3D | 3D |
| W1/WL1 × 100% | 35 | 35 | 35 | 24 |
| W2/WL1 × 100% | 39 | 39 | 39 | 27 |
| W1/W2 × 100% | 90 | 90 | 90 | 90 |
| Presence of lug grooves in | No | No | No | No |
| center land portion | | | | |
| Presence of bent portion of lug | No | Yes | Yes | Yes |
| groove in intermediate land | | | | |
| portion | | | | |
| Bend angle (°) of lug groove | — | 100 | 100 | 100 |
| in intermediate land portion | | | | |
| Steering stability on snow: | 100 | 103 | 105 | 99 |
| Steering stability on dry road | 100 | 97 | 99 | 105 |
| surfaces | | | | |

| | Example | Example | Example | Example | Example |
|---|---|---|---|---|---|
| | 1 | 2 | 3 | 4 | 5 |
| Shape of the sipe | 3D | 3D | 3D | 3D | 3D |
| W1/WL1 × 100% | 30 | 28 | 30.4 | 30 | 30 |
| W2/WL1 × 100% | 33 | 33 | 32 | 33 | 33 |
| W1/W2 × 100% | 91 | 85 | 95 | 91 | 91 |
| Presence of lug grooves in center | No | No | No | Yes | Yes |
| land portion | | | | | |
| Presence of bent portion of lug | Yes | Yes | Yes | Yes | Yes |
| groove in intermediate land portion | | | | | |
| Bend angle (°) of lug groove in | 100 | 100 | 100 | 100 | 45 |
| intermediate land portion | | | | | |
| Steering stability on snow: | 103 | 103 | 103 | 105 | 107 |
| Steering stability on dry road | 103 | 104 | 103 | 103 | 103 |
| surfaces | | | | | |

As can be seen from Table 1, in each of the tires of Examples 1 to 5, steering stability on dry road surfaces and steering stability on snow (snow performance) were enhanced in a well-balanced manner, compared with the Conventional Example. On the other hand, in each of the tires of Comparative Examples 1 to 3, steering stability on dry road surfaces and snow performance were not enhanced in a well-balanced manner.

1. A pneumatic tire, comprising:
a tread portion extending in a tire circumferential direction and having an annular shape;
a pair of sidewall portions disposed on both sides of the tread portion; and
a pair of bead portions disposed on an inner side in a tire radial direction of the pair of sidewall portions,
the tread portion comprising a pair of inner main grooves extending in the tire circumferential direction on both sides of a tire equator and a pair of outer main grooves extending in the tire circumferential direction on an outer side of the pair of inner main grooves,
a center land portion being defined between each inner main groove of the pair of inner main grooves,
intermediate land portions each being defined between one inner main groove of the pair of inner main grooves and one outer main groove of the pair of outer main grooves,
shoulder land portions being defined on an outer side of the pair of outer main grooves,
each of the center land portion, the intermediate land portions, and the shoulder land portions comprising a plurality of sipes having a three-dimensional shape, the plurality of sipes being disposed at intervals in the tire circumferential direction,
each of the intermediate land portions comprising a plurality of lug grooves comprising a bent portion, the plurality of lug grooves being disposed at intervals in the tire circumferential direction,
each of the plurality of lug grooves comprising the bent portion comprising one end portion that opens to one outer main groove of the pair of outer main grooves and an other end portion that terminates within an intermediate land portion,
a groove width W1 of the pair of inner main grooves falling within a range of from 28% to 33% with respect to a width of the center land portion and a width of the intermediate land portions, and
a groove width W2 of the pair of outer main grooves falling within a range of from 28% to 33% with respect to the width of the center land portion and the width of the intermediate land portions.

2. The pneumatic tire according to claim 1, wherein the groove width W1 of each inner main groove of the pair of inner main grooves and the groove width W2 of each outer main groove of the pair of outer main grooves satisfy the a relationship W1<W2.

3. The pneumatic tire according to claim 1, wherein the groove width W1 of each inner main groove of the pair of inner main grooves and the groove width W2 of each outer main groove of the pair of outer main grooves satisfy a relationship 0.85≤W1/W2≤0.95.

4. The pneumatic tire according to claim 1, wherein each of the plurality of lug grooves in the intermediate land portions comprises the bent portion with an acute angle, and the plurality of sipes having the three-dimensional shape formed in the intermediate land portions and the plurality of lug grooves comprising the bent portion communicate with each other in the intermediate land portions.

5. The pneumatic tire according to claim 1, wherein a plurality of lug grooves extending in the tire width direction are formed in the center land portion, the plurality of sipes having the three-dimensional shape formed in the center land portion and the plurality of lug grooves formed in the center land portion are connected to each other in the center land portion, and each of the plurality of sipes having the three-dimensional shape formed in the center land portion and each of the plurality of lug grooves formed in the center land portion open to either inner main groove of the pair of inner main grooves.

6. The pneumatic tire according to claim 1, wherein each of the plurality of lug grooves comprising the bent portion comprises a first groove portion extending from the one end portion to a bend point and a second groove portion extending from the bend point to the other end portion, an intersection angle formed by the first groove portion formed in the intermediate land portions and one of the plurality of sipes having the three-dimensional shape formed in the intermediate land portions falls within a range of from 45° to 90°, and a length a of the first groove portion and a length b of the second groove portion satisfy the relationship 0.05×a≤b≤0.4×a.

7. The pneumatic tire according to claim 1, wherein the shoulder land portions comprise a plurality of lug grooves extending in the tire width direction, the plurality of lug grooves formed in the shoulder land portions not communicating with an outer main groove of the pair of outer main grooves, and a plurality of longitudinal grooves connecting, in the tire circumferential direction, the lug grooves adjacent to each other in the shoulder land portions.

8. The pneumatic tire according to claim 2, wherein the groove width W1 of each inner main groove of the pair of inner main grooves and the groove width W2 of each outer main groove of the pair of outer main grooves satisfy a relationship 0.85≤W1/W2≤0.95.

9. The pneumatic tire according to claim 8, wherein each of the plurality of lug grooves in the intermediate land portions comprises the bent portion with an acute angle, and the plurality of sipes having the three-dimensional shape formed in the intermediate land portions and the plurality of lug grooves comprising the bent portion communicate with each other in the intermediate land portions.

10. The pneumatic tire according to claim 9, wherein a plurality of lug grooves extending in the tire width direction are formed in the center land portion, the plurality of sipes having the three-dimensional shape formed in the center land portion and the plurality of lug grooves formed in the center land portion communicate with each other in the center land portion, and each of the plurality of sipes having the three-dimensional shape formed in the center land portion and each of the plurality of lug grooves formed in the center land portion open to either inner main groove of the pair of inner main grooves.

11. The pneumatic tire according to claim 10, wherein each of the plurality of lug grooves comprising the bent portion formed in the intermediate land portions comprises a first groove portion extending from the one end portion to a bend point and a second groove portion extending from the bend point to the other end portion, an intersection angle formed by the first groove portion formed in the intermediate land portions and one of the plurality of sipes having the three-dimensional shape formed in the intermediate land portions falls within a range of from 45° to 90°, and a length a of the first groove portion and a length b of the second groove portion satisfy a relationship 0.05×a≤b≤0.4×a.

12. The pneumatic tire according to claim 11, wherein the shoulder land portions comprise a plurality of lug grooves extending in the tire width direction, the plurality of lug grooves formed in the shoulder land portions not communicating with an outer main groove of the pair of outer main grooves, and a plurality of longitudinal grooves connecting, in the tire circumferential direction, the lug grooves adjacent to each other in the shoulder land portions.
